(19) United States
(12) Patent Application Publication
(10) Pub. No.: US 2009/0306922 A1
(43) Pub. Date: Dec. 10, 2009

(54) Method and System for Classifying Defect Distribution, Method and System for Specifying Causative Equipment, Computer Program and Recording Medium

(75) Inventor: Tetsuro Toyoshima, Nara-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/226,711

(22) PCT Filed: Apr. 25, 2007
(86) PCT No.: PCT/JP2007/058916

§ 371 Date: Feb. 9, 2009

(30) Foreign Application Priority Data
Apr. 27, 2006 (JP) 2006-123408

(51) Int. Cl. G06F 19/00; G06F 15/00; G01N 37/00; G06F 17/18

(52) U.S. Cl. 702/83; 702/183; 702/179

(57) ABSTRACT

A production line includes an inspection step for acquiring inspection information representing positions of defects on each of substrates after an end of specified steps. With respect to m substrates subjected to the inspection step, a surface of each of the substrates is segmented into n regions, and defect density information having (m×n) components, which represent densities of defects contained in the regions, respectively, is acquired based on the inspection information. From the defect density information having (m×n) components, statistically mutually independent p (where p<m) features are extracted. Similarities between the p features and the defect density information as to the individual substrates are determined, respectively, and the substrates are classified for each one of the p features according to the similarities.

### TECHNICAL FIELD

The present invention relates to defect distribution classification methods and, more specifically, to a defect distribution classification method for classifying defect distributions on substrates processed in a production line including a plurality of steps.

The invention also relates to a defect distribution classification system suitable for implementation of such a defect distribution classification method.

The invention also relates to a causal equipment determination method for implementing such a defect distribution classification method and moreover, based on the classification result, determining abnormal steps or equipment units that cause product failures or the like in a production line including a plurality of steps.

The invention still also relates to a causal equipment determination system suitable for implementation of such a causal equipment determination method.

The invention further relates to a computer program for enabling a computer to run such a defect distribution classification method or causal equipment determination method.

The invention still further relates to a computer-readable recording medium in which such a computer program is recorded.

### BACKGROUND ART

Conventionally, in multi-step production lines for semiconductor devices, thin film devices and the like, it has been practiced to execute pattern defect inspections or foreign matter inspections (in-line inspections) every few some sequential steps with a view to achieving improvement and stabilization of product yield. In this case, there is introduced a system for classifying defect distributions on substrates based on inspection information acquired by the in-line inspections and moreover determining abnormal steps or equipment units that cause product failures or the like (so-called ‘causal equipment’ or ‘problematic equipment’) based on a result of the classification.

In JP H11-45919 A, failure counts in each grated pixel are added up with respect to a plurality of semiconductor substrates, by which failure distribution image data shown by gray values are prepared. Also, the prepared failure distribution image data are checked and analyzed against a plurality of case databases that allow the causes of failure occurrences to be deduced, by which the causes of failure occurrences are investigated.

In JP 2003-59984 A, defect distributions on substrates are classified into any one of distribution feature categories including a) iterative defects, b) dense defects, c) linear defects, d) annular/massive defects, and e) random defects.

In JP 2005-142406 A, divisional regions common to a plurality of product types of semiconductor devices are set within a wafer surface, and feature quantities are calculated by using numbers of failure chip regions contained in the divisional regions, respectively, for each of wafers. Then, the wafers are classified by using the resulting feature quantities.

Further, in JP 2005-197629 A, “automatic abnormality detection” is performed based on product inspection information (defect distribution information or appearance information) as to one product substrate, where if there is some abnormality, specified information is loaded from a host database to perform common path analysis so that a problematic equipment is determined. As the method for performing the “automatic abnormality detection,” defect distribution states are analyzed and a regional defect having any of annular, massive, linear and circular-arc four significant configuration patterns, if detected, is decided as an “abnormality.” Alternatively, presence or absence of any abnormality is decided depending on the number of defects in assigned classes (where class assignation is previously done for each product-type and step according to a recipe, or otherwise the assignation may be other than by product-type and step) based on defect appearance information.

### DISCLOSURE OF INVENTION

However, in the method of JP H11-45919 A, the case databases (library) have to be built up in advance by persons, giving rise to a problem that much time and labor are required.

In the methods of JP 2003-59984 A and JP 2005-142406 A, there is a need for previously setting distribution feature categories representing the types of defect distributions, or divisional regions within the wafer surface, by manpower. For this reason, even if inspection data are collected, those data cannot immediately be introduced into a step monitoring task of the production line. Also, when the type or production process of a device to be produced or the type of equipment units has been changed, there arises a need for rebuilding rules (identification rules) for extraction of defect distribution features and redoing their installation by persons because the distribution feature categories or the divisional regions have no universality. Therefore, much time and labor is required for maintenance of identification rules, so that these methods are less likely to be widespread into field production lines.

Although JP 2005-197629 A includes a description of “automatic abnormality detection,” the method of JP 2005-197629 A has a need for previously setting by persons the annular, massive, linear and circular-arc four significant configuration patterns or the classes of defects as a precondition for execution of “automatic abnormality detection”. That is, there is a need for setting rules (identification rules) for extraction of defect distribution features, or logics for making a decision as to the presence or absence of any abnormality, by persons based on their past experiences.

As shown above, prior arts including JP H11-45919 A, JP 2003-59984 A, JP 2005-142406 A and JP 2005-197629 A require human intervention for the classification of defect distributions or the determination of causal equipment units, hence inconvenient.

Accordingly, an object of the present invention is to provide a defect distribution classification method capable of automatically extracting and classifying defects on substrates processed in a production line including a plurality of steps without human intervention.

Another object of the invention is to provide a defect distribution classification system suitable for implementation of such a defect distribution classification method.

Still another object of the invention is to provide a causal equipment determination method capable of determining abnormal steps or equipment units that cause product failures or the like in a production line including a plurality of steps without human intervention.

Yet another object of the invention is to provide a causal equipment determination system suitable for implementation of such a causal equipment determination method.

A further object of the invention is to provide a computer program for enabling a computer to run such a defect distribution classification method or causal equipment determination method.

A still further object of the invention is to provide a computer-readable recording medium in which such a computer program is recorded.

In order to accomplish the object, the present invention provides a defect distribution classification method for extracting and classifying defects on substrates processed in a production line including a plurality of steps, wherein
the production line includes an inspection step for acquiring inspection information representing positions of defects on each of the substrates after an end of specified steps, the method comprising:
with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
extracting statistically mutually independent p (where p is a natural number less than m) features from the defect density information having (m×n) components; and
determining similarities between the p features and the defect density information as to the individual substrates, respectively, to classify the substrates for each one of the p features according to the similarities.

In the defect distribution classification method of this invention, the step of segmenting a surface of each of the substrates into n regions to acquire defect density information having (m×n) components, the step of extracting the p features, and the step of determining similarities between the p features and the defect density information as to the individual substrates to classify the substrates for each one of the p features according to the similarities can be performed uniformly by the same rules, respectively, regardless of the type and production process of devices to be produced and the type of equipment units. Also, each of the processes as mentioned above is executable even without previously setting case databases (library) or defect distribution patterns, classes and the like by persons. Therefore, according to the defect distribution classification method of this invention, defects on substrates processed in the production line including a plurality of steps can be automatically extracted and classified without human intervention. As a result of this, the defect distribution classification method can be applied immediately to the monitoring task of the production line. Also, the defect distribution classification method is utilizable at all times by virtue of its no requiring maintenance of rules (identification rules) for identifying defect distributions even when the type or production process of devices to be produced or the type of equipment units has been changed.

In the defect distribution classification method of one embodiment,
the defect density information is a set of first vectors each having n components associated with the m substrates,
the p features are second vectors each having n components, and
the similarities are determined as correlation coefficients, inner products or covariances between the first vectors as to each of the substrates and the p second vectors.

In the defect distribution classification method of this one embodiment, the similarities can objectively be determined.

The present invention also provides a defect distribution classification system for extracting and classifying defects on substrates processed in a production line including a plurality of steps, wherein
the production line includes an inspection step for acquiring inspection information representing positions of defects on each of the substrates after an end of specified steps, the system comprising:
a defect density distribution acquisition section for, with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
a feature extraction section for extracting statistically mutually independent p (where p is a natural number less than m) features from the defect density information having (m×n) components; and
a classification result acquisition section for determining similarities between the p features and the defect density information as to the individual substrates, respectively, to classify the substrates for each one of the p features according to the similarities.

In the defect distribution classification system of this invention, the processing by the defect density distribution acquisition section, the processing by the feature extraction section, and the processing by the classification result acquisition section can be performed uniformly by the same rules, respectively, regardless of the type and production process of devices to be produced and the type of equipment units. Also, each of the processes as mentioned above is executable even without previously setting case databases (library) or defect distribution patterns, classes and the like by persons. Therefore, according to the defect distribution classification system of this invention, defects on substrates processed in the production line including a plurality of steps can be automatically extracted and classified without human intervention. As a result of this, the defect distribution classification system can be applied immediately to the monitoring task of the production line. Also, the defect distribution classification system is utilizable at all times by virtue of its no requiring maintenance of rules (identification rules) for identifying defect distributions even when the type or production process of devices to be produced or the type of equipment units has been changed.

The present invention also provides a failure-cause equipment determination method for determining a equipment unit that has caused failure occurrence in a production line that executes a plurality of steps on substrates by using one or more equipment units enabled to execute the individual steps, wherein
the production line includes an inspection step for acquiring inspection information representing positions of defects on each of the substrates after an end of specified steps, the method comprising:
with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
extracting statistically mutually independent p (where p is a natural number less than m) features from the defect density information having (m×n) components;
determining similarities between the p features and the defect density information as to the individual substrates, respectively, to classify the substrates for each one of the p features according to the similarities; and
extracting a causal equipment unit that has caused failure occurrence out of the plurality of equipment units based on the obtained classification result and production history information for identifying equipment units by which the substrates have been subjected to the individual steps, respectively.

In the causal equipment determination method of this invention, the step of segmenting a surface of each of the substrates into n regions to acquire defect density information having (m×n) components, the step of extracting the p features, the step of determining similarities between the p features and the defect density information as to the individual substrates to classify the substrates for each one of the p features according to the similarities, and the step of extracting a causal equipment unit that has caused failure occurrence out of the plurality of equipment units can be performed uniformly by the same rules, respectively, regardless of the type and production process of devices to be produced and the type of equipment units. Also, each of the processes as is mentioned above is executable even without previously setting case databases (library) or defect distribution patterns, classes and the like by persons. Therefore, according to the causal equipment determination method of this invention, an abnormal step or equipment unit that causes a product failure or the like in the production line including a plurality of steps can be determined without human intervention. As a result of this, the causal equipment determination method can be applied immediately to the monitoring task of the production line. Also, the causal equipment determination method is utilizable at all times by virtue of its no requiring maintenance of rules (identification rules) for identifying defect distributions even when the type or production process of devices to be produced or the type of equipment units has been changed.

The present invention also provides a failure-cause equipment determination system for determining an equipment unit that has caused failure occurrence in a production line that executes a plurality of steps on substrates by using one or more equipment units enabled to execute the individual steps, wherein
the production line includes an inspection step for acquiring inspection information representing positions of defects on each of the substrates after an end of specified steps, the system comprising:
a defect density distribution acquisition section for, with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
a feature extraction section for extracting statistically mutually independent p (where p is a natural number less than m) features from the defect density information having (m×n) components;
a classification result acquisition section for determining similarities between the p features and the defect density information as to the individual substrates, respectively, to classify the substrates for each one of the p features according to the similarities; and
a causal equipment extraction section for extracting a causal equipment unit that has caused failure occurrence out of the plurality of equipment units based on the obtained classification result and production history information for identifying equipment units by which the substrates have been subjected to the individual steps, respectively.

In the causal equipment determination system of this invention, the processing by the defect density distribution acquisition section, the processing by the feature extraction section, the processing by the classification result acquisition section, and the processing by the causal equipment extraction section can be performed uniformly by the same rules, respectively, regardless of the type and production process of devices to be produced and the type of equipment units. Also, each of the processes as mentioned above is executable even without previously setting case databases (library) or defect distribution patterns, classes and the like by persons. Therefore, according to the causal equipment determination system of this invention, defects on substrates processed in the production line including a plurality of steps can be automatically extracted and classified without human intervention. As a result of this, the causal equipment determination system can be applied immediately to the monitoring task of the production line. Also, the causal equipment determination system is utilizable at all times by virtue of its no requiring maintenance of rules (identification rules) for identifying defect distributions even when the type or production process of devices to be produced or the type of equipment units has been changed.

The causal equipment determination system of one embodiment further comprises:
a display processing section for forming a first defect distribution superimposed image by superimposing, on one another, defect distributions of substrates processed by the causal equipment unit and further forming a second defect distribution superimposed image by superimposing, on one another, defect distributions of substrates processed by equipment units other than the causal equipment unit in one same step as a step executed by the causal equipment unit, and then displaying the first defect distribution superimposed image and the second defect distribution superimposed image in contrast on one display screen.

In the causal equipment determination system of this one embodiment, whether or not a causal equipment unit determined by this system is really the cause of the abnormality can be intuitively grasped through the sense of vision and promptly and easily confirmed by a user (including the system operator, which applies also hereinafter).

The present invention also provides a computer program for enabling a computer to run the above defect distribution classification method.

When the computer program of this invention is executed by a computer, the defect distribution classification method or the causal equipment determination method as described above can be embodied.

The present invention also provides a computer-readable recording medium in which the above computer program is recorded.

When the computer program recorded on the recording medium of this invention is read and executed by a computer, the defect distribution classification method or the causal equipment determination method as described above can be embodied.

### BRIEF DESCRIPTION OF DRAWINGS

FIG. 1 illustrates a production line 30 in which steps are monitored by a production line monitoring system according to an embodiment to which the present invention is applied;

FIG. 2 is a view showing a block configuration of a causal equipment determination system including a defect distribution classification system according to an embodiment of the invention;

FIG. 3A is a chart for explaining a case in which two vectors are independent of each other;

FIG. 3B is a chart for explaining a case in which two vectors are uncorrelated with, but not independent of, each other;

FIG. 4 is a diagram for explaining observation process and restoration process by independent component analysis;

FIG. 5A is a diagram showing an aspect in which one substrate is segmented into n rectangular regions;

FIG. 5B is a diagram illustrating an aspect in which a feature vector is expressed in a map form resulting when independent components are extracted from a set of inspected substrates;

FIG. 5C is a diagram illustrating an aspect in which a feature vector is expressed in a map form resulting when independent components are extracted from a set of inspected substrates;

FIG. 6 is a diagram illustrating defect distribution vector of one inspected substrate and p feature vectors of independent components;

FIG. 7A is a diagram illustrating defect density information as to m substrates and p feature vectors of independent components extracted from the defect density information;

FIG. 7B is a diagram showing a result of determining similarities of the m substrates to p features, respectively;

FIG. 8 is a diagram showing a result of correlating the similarities of the m substrates to the features with production history, where the similarities are expressed by actual numerical values;

FIG. 9 is a diagram showing a result of correlating the similarities of the m substrates to the features with production history, where the similarities are expressed by logical values (binary values of 1 and 0); and

FIG. 10 is a diagram schematically showing steps performed by the causal equipment determination system of one embodiment of the invention from receiving inspection information and history information from a step information collection system, and classifying failure distributions, until determining a causal equipment unit.

### BEST MODE FOR CARRYING OUT THE INVENTION

Hereinbelow, the present invention will be described in detail by way of embodiments thereof illustrated in the accompanying drawings.

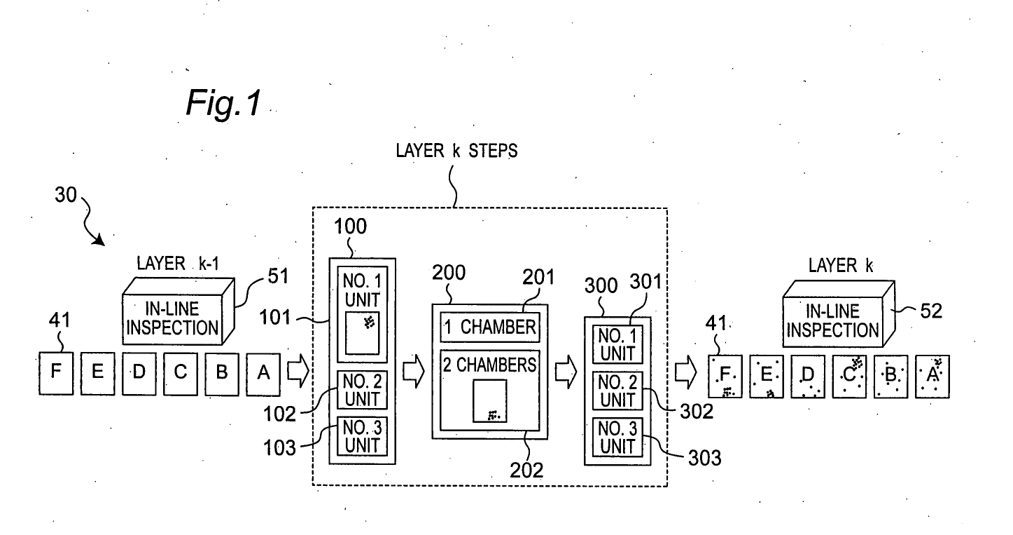

FIG. 1 illustrates a production line 30 in which steps are monitored by a production line monitoring system according to an embodiment to which the present invention is applied.

Generally, a production line of thin film devices or semiconductor devices is composed of multiple steps, from reception of substrates to completion of devices, to be executed sequentially on production lot by production lot basis. Thin film devices, which are to be segmented into cells or chips at the product stage, are processed in the form of substrate or wafer on the way of production steps.

Part of such a thin film device production line 30 is shown in FIG. 1. In this example, the production line 30 includes an in-line inspection step 51 subsequent to an end of layer (k−1) steps, a layer k processing step 100, a processing step 200 and a processing step 300, and an in-line inspection step 52 subsequent to the layer k steps. Substrates 41 (six substrates A-F in the example shown) as an processing object are processed through these steps.

The processing steps 100, 200, 300 are, for example, film deposition step, exposure step, and etching step. In the steps 100, 200 and 300, a plurality of equipment units enabled to execute the steps, respectively, are provided to shorten the production time. More specifically, a total of three units, i.e. No. 1 unit 101, No. 2 unit 102 and No. 3 unit 103, are provided in the processing step 100. A total of two units, i.e. a first chamber 201 and a second chamber 202, are provided in the processing step 200. A total of three units, i.e. No. 1 unit 301, No. 2 unit 302 and No. 3 unit 303, are provided in the processing step 300. Then, a plurality of substrates that have flowed up in the production line 30 are processed in parallel by a plurality of equipment units, respectively, in the processing steps 100, 200, 300.

The in-line inspection steps 51, 52 are intended, in this example, to perform pattern defect inspections to acquire information representing positions and sizes of defects on the individual substrates, appearance information representing appearance inspection results and the like as inspection information.

It is noted here that in a production line for thin film devices having multiple layers, such an in-line inspection step is executed after an end of processing steps for each of the layers.

In the production line 30 as shown above, when one equipment unit in one step has fallen into a malfunction, there are some cases where, with respect to substrates processed by the malfunctioning equipment unit, defects occur dense at a particular position on the substrates. For example, when the No. 1 unit 101 of the step 100 has fallen into a malfunction, there may be a case where, with respect to substrates A, C processed by the No. 1 unit 101, defects occur dense at an upper right corner of those substrates A, C. Also, when the second chamber 202 of the step 200 has fallen into a malfunction, there may be a case where, with respect to substrates E, F processed by the second chamber 202, defects occur dense at a lower center portion of those substrates E, F. Like this, when one equipment unit of one step has fallen into a malfunction, there is a tendency that, with respect to substrates processed by the malfunctioning equipment unit, a defect distribution unique to the malfunctioning equipment unit is observed.

In typical step monitoring, a total defect count per substrate is determined, and upon occurrence of a total defect count over a monitoring criterion, it is decided that an abnormality has occurred, followed by taking measures such as examining production history of the substrate, and determining a causal equipment unit to which the abnormality occurrence is attributed. However, with such a method, presence or absence of abnormality could not be detected for cases in which the total defect count per substrate is under the monitoring criterion. Further, as in the patent documents described before, with a method in which rules (identification rules) for extraction of defect distribution features are defined by persons to classify defect distributions on substrates, accumulation of past experiences would be required while much time and labor would be taken.

In the present invention, on the other hand, if there is a deviation among inspection result distributions of equipment units processed by one identical step of one identical layer, it is decided that an abnormality has occurred. Since substrates pass through the equipment units sequentially, inspection result information obtained by an in-line inspection step plays the role as a sensor that detects states of the individual equipment units.

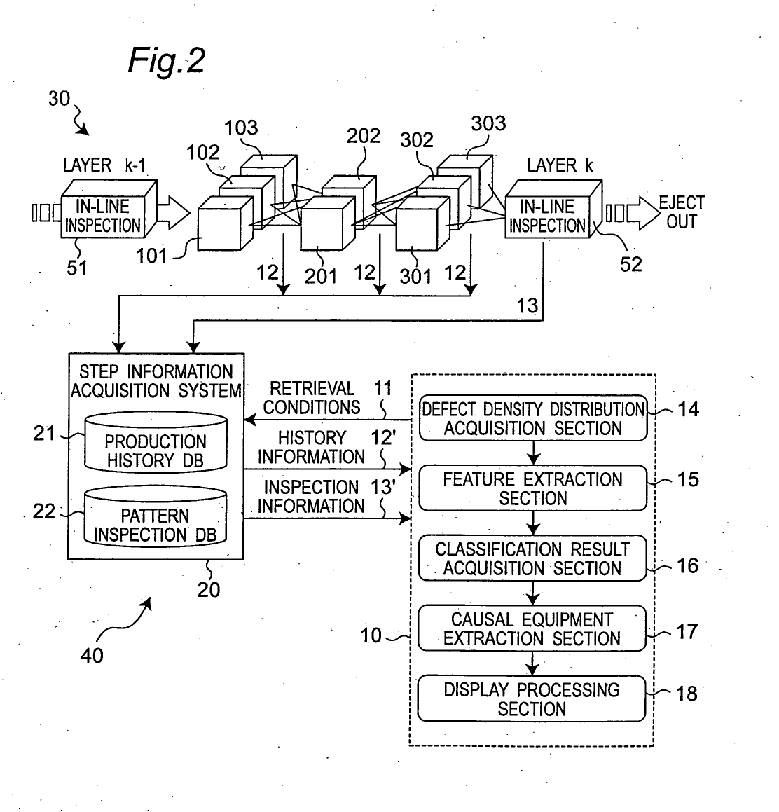

As shown in FIG. 2, a production line monitoring system 40 of one embodiment is composed roughly of a step information collection system 20, and a causal equipment determination system 10 including a defect distribution classification system.

The step information collection system 20 includes a production history DB (database) 21 for storing production history information 12, and a pattern inspection DB 22 for storing inspection information 13. The production history information 12 contains information for determining equipment units that have executed the processing of substrates in the individual steps of the individual layers. Also, the inspection information 13 contains defect distribution information representing positions and sizes of defects on the individual substrates, and the like.

These processing history information 12 and inspection information 13 are transmitted from the production line 30 to the step information collection system 20 via communication means (not shown) in this example. Alternatively, the processing history information 12 and the inspection information 13 may also be transferred from a known CIM (Computer Integrated Manufacturing) system for performing production control of substrates, i.e., a system for totally managing a flow sequence of all the steps of material supply, to panel production, to inspection and further to storage of products.

The causal equipment determination system 10 includes a defect density distribution acquisition section 14, a feature extraction section 15, a classification result acquisition section 16, a causal equipment extraction section 17, and a display processing section 18. The causal equipment determination system 10 further includes communication means (not shown) which transmits retrieval conditions 11 as to target period, target layer and the like to the step information collection system 20 and which receives production history information 12′ and inspection information 13′ matching the retrieval conditions 11 from the step information collection system 20.

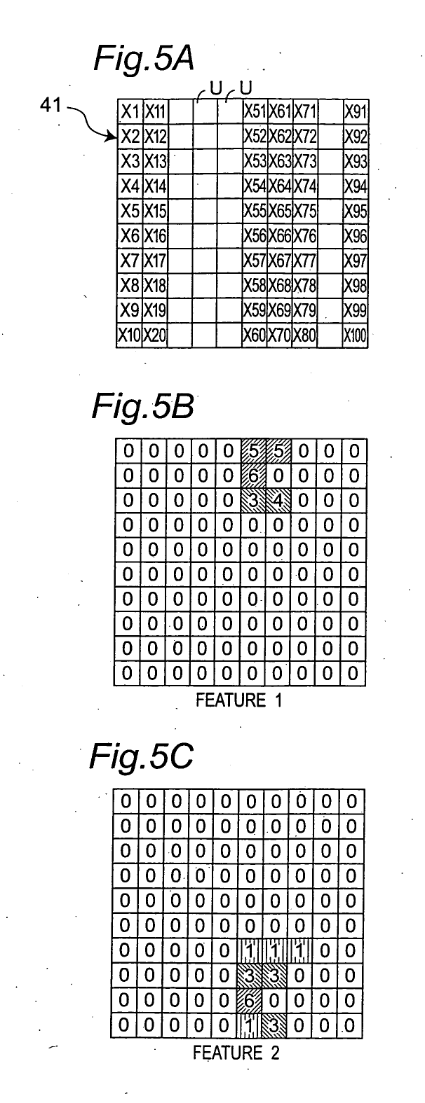

The defect density distribution acquisition section 14 segments, with respect to m (where m is a natural number of 2 or more) substrates subjected to the inspection step 52 in this example, a surface of each of the substrates into n (where n is a natural number of 2 or more) rectangular regions U as shown in FIG. 5A. In the example of FIG. 5A, the surface of each substrate is segmented into 10 rows and 10 columns, where n=10.

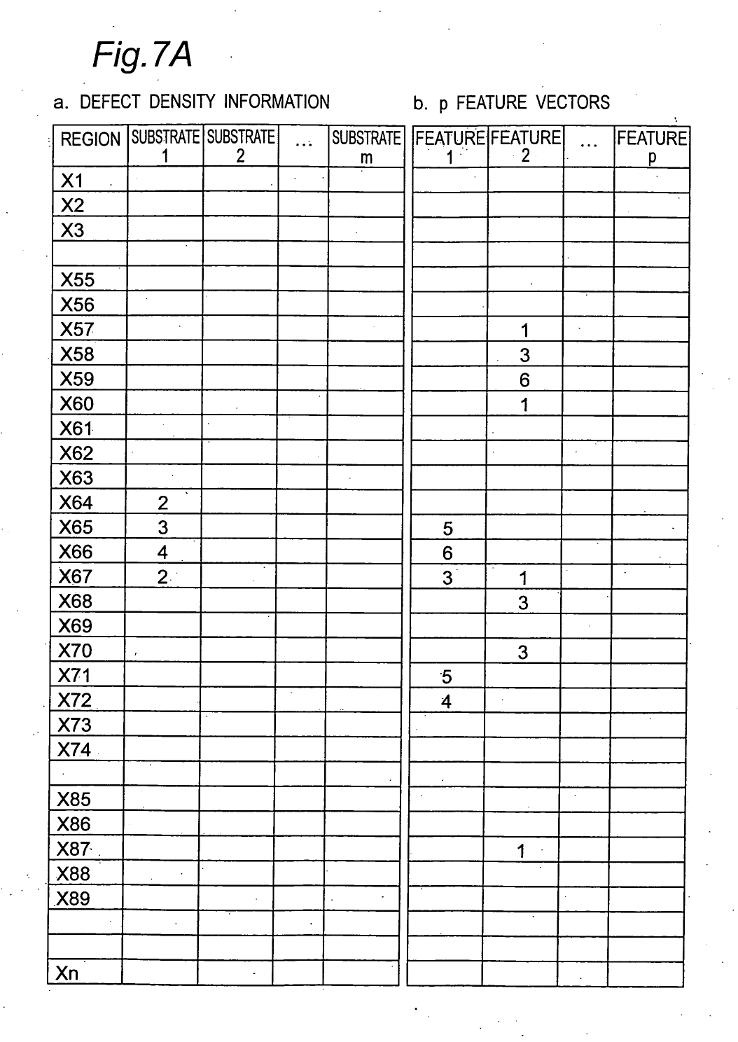

Furthermore, the defect density distribution acquisition section 14 acquires defect density information containing (m×n) components, which represent defect densities of the individual rectangular regions U, respectively, based on the inspection information 13. In this example, the defect density information is a set of first vectors (hereinafter, referred to as ‘defect distribution vectors’) each having n components as to the m substrates. In this example, it is assumed that the defect density information is determined as a matrix X of m rows and n columns as shown in part (a) of FIG. 7A.

The feature extraction section 15 extracts statistically mutually independent p (where p is a natural number less than m) features from the defect density information (m-row, n-column matrix) X by using an independent component analysis technique. In this example, as shown in part (b) of FIG. 7A, the p features (expressed as ‘Feature 1’, ‘Feature 2’, . . . , ‘Feature p’ in the figure) are second vectors (hereinafter, referred to as ‘feature vectors’) each having n components.

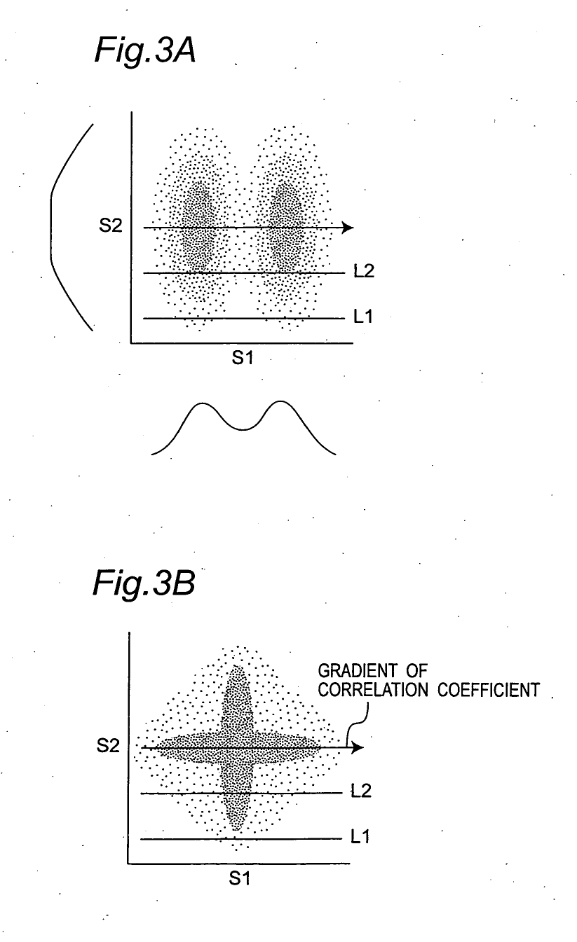

In this connection, that a vector S1 and a vector S2 are mutually independent means that the vector S1 and the vector S2 are uncorrelated to each other and that a component distribution of the vector S1 is not affected by a component distribution of the vector S2. For instance, on the assumption that two out of p feature vectors are vectors S1, S2, in the example shown in FIG. 3A, even if components of the vector S2 are changed as depicted by cross sections L1, L2, the component distribution (a distribution having two peaks in the example shown) of the vector S1 is not affected by the change. Accordingly, the vector S1 and the vector S2 are independent. Meanwhile, in the example shown in FIG. 3B, in which the vector S1 and the vector S2 are uncorrelated to each other, when components of the vector S2 have been changed as in the cross sections L1, L2, the component distribution of the vector S1 is changed from abrupt to gentle peaks by the change, thus being affected. Therefore, the vector S1 and the vector S2 are not independent.

The process that the feature extraction section 15 extracts feature vectors will be described later in detail.

The classification result acquisition section 16 determines similarities between defect distribution vectors and the p feature vectors with respect to the substrates, respectively. The similarities are determined as correlation coefficients, inner products or covariances between defect distribution vectors as to each of the substrates and the p feature vectors. Then, the classification result acquisition section 16 classifies the individual substrates for each of the p features according to the similarities.

Based on a classification result obtained by the classification result acquisition section 16 and the production history information 12′ received from the step information collection system 20, the causal equipment extraction section 17 performs a common path analysis (an analysis of pursuing which equipment unit has been used in common to process a plurality of substrates having similar defect distributions) to extract a causal equipment unit that has caused failure occurrence out of a plurality of equipment units.

In this connection, the processing by the defect density distribution acquisition section 14, the processing by the feature extraction section 15, the processing by the classification result acquisition section 16, and the processing by the causal equipment extraction section 17 can be performed uniformly by the same rules, respectively, regardless of the type and production process of devices to be produced and the type of equipment units. Also, each of the processes as mentioned above is executable even without previously setting case databases (library) or defect distribution patterns, classes and the like by persons. Therefore, with use of this causal equipment determination system 10, defects on substrates processed in the production line 30 including a plurality of steps can be automatically extracted and classified without human intervention. As a result of this, the causal equipment determination system 10 can be applied immediately to the monitoring task of the production line. Also, the causal equipment determination system 10 is utilizable at all times by virtue of its no requiring maintenance of rules (identification rules) for identifying defect distribution patterns even when the type or production process of devices to be produced or the type of equipment units has been changed.

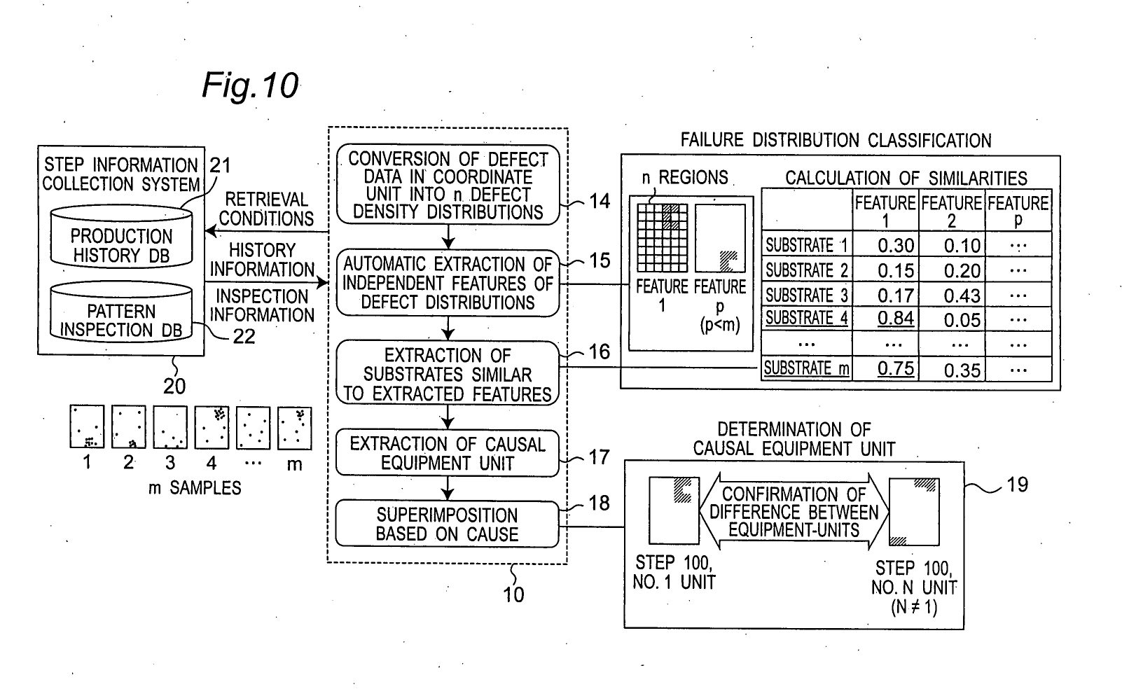

The display processing section 18 forms a first defect distribution superimposed image by superimposing, on one another, defect distributions of individual substrates processed by the causal equipment unit, and further forms a second defect distribution superimposed image by superimposing, on one another, defect distributions of individual substrates processed by equipment units other than the causal equipment unit in the same step as that executed by the causal equipment unit. Then, the display processing section 18 displays in contrast the first defect distribution superimposed image and the second defect distribution superimposed image on a display screen (indicated by reference numeral 19 in FIG. 10). In the example of FIG. 10, the causal equipment unit is the No. 1 unit 101 of the step 100, and the first defect distribution superimposed image is formed by superimposing, on one another, defect distributions of individual substrates subjected to the step 100 by the No. 1 unit 101. The second defect distribution superimposed image is formed by superimposing, on one another, defect distributions on the substrates subjected to the step 100 by equipment units other than the No. 1 unit 101 (specifically, No. 2 unit 102 and No. 3 unit 103). When the first defect distribution superimposed image and the second defect distribution superimposed image are displayed in contrast on one display screen 19 as in this case, whether or not a causal equipment unit determined by this system is really the cause of the abnormality can be intuitively grasped through the sense of vision and promptly and easily decided by a user (including the system operator, which applies also hereinafter). As the second defect distribution superimposed image, although the defect distributions on the substrates subjected to the step 100 by the equipment units other than the No. 1 unit 101 (specifically, No. 2 unit 102 and No. 3 unit 103) are superimposed on one another above, yet it is also possible to form a superimposed image of defect distributions on substrates processed by the No. 2 unit and a superimposed image of defect distributions on substrates processed by the No. 3 unit, separately. In this case, superimposed images are provided by a number corresponding to equipment units present in one identical step. That is, the second defect distribution superimposed image may be formed in plurality for individual devices without being limited to one type.

As can be understood by those skilled in the art, such a system 10 can be implemented by a computer, more particularly, a personal computer. Operations of the individual sections 14, 15, . . . , 18 can be implemented by a computer program (software). Such a computer program may be either stored in a hard disk drive attached to the personal computer or previously recorded in a computer-readable recording medium (compact disc (CD) or digital versatile disc (DVD) or the like) and read by a reproducing device (CD drive or DVD drive or the like) upon running of the program.

(1) Next, the process that the feature extraction section 15 extracts feature vectors by using the independent component analysis technique is described below concretely.

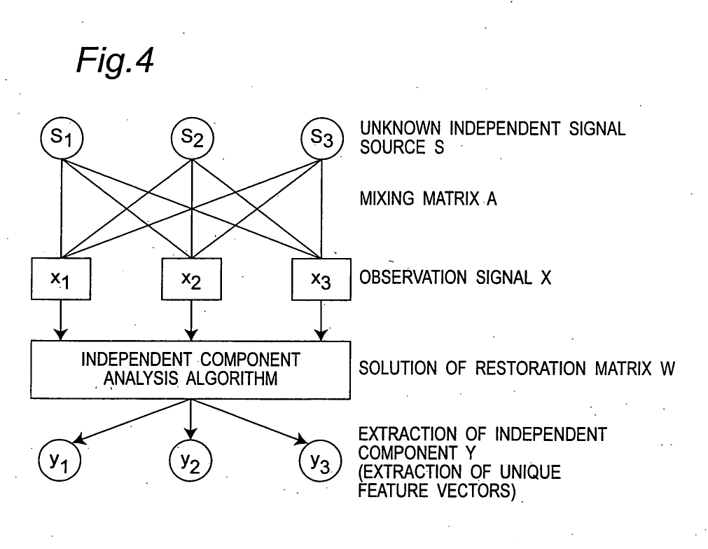

An algorithm for independent component analysis is known as a technique for restoring signals of original signal sources, that is, for example, when signals s₁, s₂, s₃ (a vector having these components is assumed as vector S) issued from a plurality of signal sources are superimposed and observed as observation signals x₁ x₂, x₃ (a vector having these components is assumed as vector X) by a plurality of microphones, the signals of the original signal sources are restored from those observation signals x₁ x₂, x₃ as shown in FIG. 4. In FIG. 4, an aspect of superimposition of the signals s₁, s₂, s₃ is represented by a mixing matrix A. Also, the restored signals are represented by y₁, y₂, y₃ (a vector having these components is assumed as vector Y). In this embodiment, it is assumed that in FIG. 4, the plurality of signal sources s₁, s₂, s₃ correspond to failure occurrence factors (failure distribution patterns) unique to equipment units, respectively, the number of observation signals x₁ x₂, x₃ (number of microphones) corresponds to the number of substrates subjected to the inspection step (hereinafter, referred to as ‘inspected substrates’), and the length of observation signals (signal occurrence time, which is assumed as t) corresponds to the number of segmented regions on each substrate. In particular, the length t of the observation signals is expressed as

t=t₁, t₂, . . . , tₙ

and the following correspondences are set:

time t₁→region 1

time t₂→region 2

time tₙ→region n.

In consideration of such correspondence relations, inspected property X of three substrates (corresponding to microphones) observed under influences of the independent factors s₁, s₂, s₃ are expressed as

x₁(t)=a₁₁s₁(t)+a₁₂s₂(t)+a₁₃s₃(t)

x₂(t)=a₂₁s₁(t)+a₂₂s₂(t)+a₂₃s₃(t)

x₃(t)=a₃₁s₁(t)+a₃₂s₂(t)+a₃₃s₃(t) (Eq. 1)

Now, given that

$$X = ( \begin{matrix}{x}_{1} \\ {x}_{2} \\ {x}_{3}\end{matrix} ) , S = ( \begin{matrix}{s}_{1} \\ {s}_{2} \\ {s}_{3}\end{matrix} ) , A = ( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ) \qquad ( Eq . 2 )$$

then the inspected property X can be expressed as

X=AS (Eq. 3)

The restored signal (estimate of signal sources S) Y can be determined by the independent component algorithm as

Y=WX

y₁(t)=w₁₁x₁(t)+w₁₂x₂(t)+w₁₃x₃(t)

y₂(t)=w₂₁x₁(t)+w₂₂x₂(t)+w₂₃x₃(t)

y₃(t)=w₃₁x₁(t)+w₃₂x₂(t)+w₃₃x₃(t) (Eq. 4)

In the independent component analysis, the independent component Y is estimated only from the observed information X absolutely without any knowledge of information about the signal source S or the mixing matrix A. When independent components are mixed, a resulting probability distribution approaches a Gaussian distribution according to the central limit theorem. Therefore, it is regarded that independent components have been extracted when non-Gaussian property of the estimated distribution Y comes to a maximum. Thus, a restoration matrix W is determined so that the non-Gaussian property comes to a local maximum, and then the observation information X is multiplied by the resulting restoration matrix W, by which the independent component Y is determined.

In this way, the feature extraction section 15 determines p feature vectors that are independent of one another. In this case, expressing components of each feature vector into a 10-row, 10-column map makes it possible to find out regions having features that are mutually independent on the substrates.

(2) After the p independent features have been determined as shown above, inspected substrates are classified in the following manner.

i) First, feature vectors of independent components (feature axes) are set.

In the case of three independent components (feature axes) as an example, the following feature vectors result:

1st feature axis S1=(S₁₁, S₁₂, . . . , S₁ᵢ, . . . , S₁ₙ)

2nd feature axis S2=(S₂₁, S₂₂, . . . , S₂ᵢ, . . . , S₂ₙ)

3rd feature axis S3=(S₃₁, S₃₂, . . . , S₃ᵢ, . . . , S₃ₙ)

It is noted here that in the case of 10 rows×10 columns=100 regions per substrate, it follows that n=100, and S₁₁, S₁₂, . . . , S₁ᵢ, . . . , S₁ₙ mean 100 components representing the first feature axis.

FIGS. 5B and 5C show an example in which with each inspected substrate segmented into 100 (n=100) regions as shown in FIG. 5A, feature vectors of independent components extracted from a set of inspected substrates are expressed in a map form.

ii) Next, similarities between defect distributions of the substrates and the feature axes are calculated.

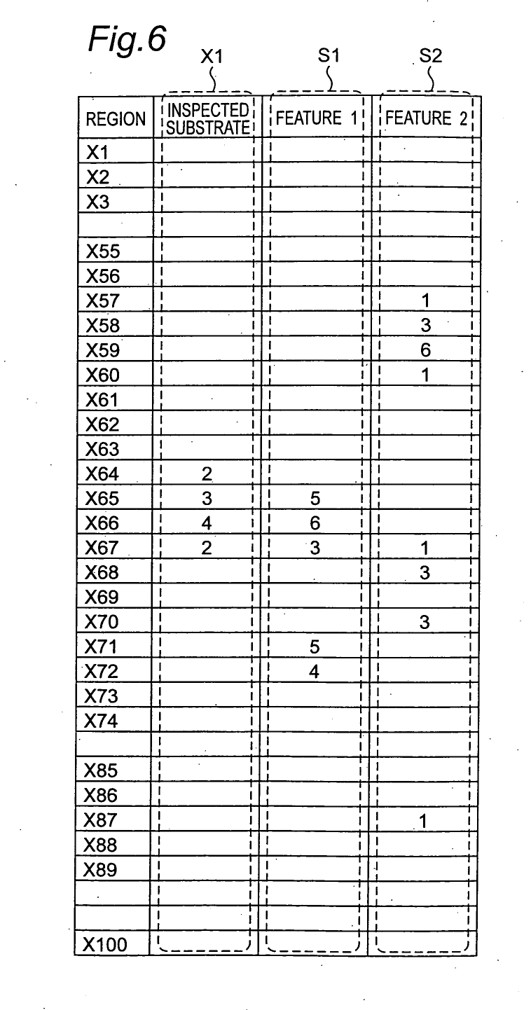

For example, as shown in FIG. 6, it is assumed that the defect distribution vector of one inspected substrate is X1 and two feature axes (feature vectors of independent components) are S1, S2 when independent components are extracted from the set of inspected substrates. In this case, if defect distribution vectors of the inspected substrate are

X₁=(x₁₁, x₁₂, . . . , x₁ᵢ, . . . , x₁ₙ),

then a similarity of the inspected substrate to, e.g., the feature axis S1 can be evaluated by a covariance S_{X1S1} or correlation coefficient r between the defect distribution vector X1 and the feature axis S1 of the inspected substrate. In this example, it is assumed that the similarity is evaluated by the correlation coefficient r.

More specifically, if average values of the vectors X1, S1 are

X̅₁, S̅₁ (Eq. 5)

then the covariance S_{X1S1} of the vectors X1, S1 can be determined as:

S_{X1S1}=Σ(X₁ᵢ− X̅₁)(S₁ᵢ− S̅₁)/n (Eq. 6)

The correlation coefficient r between the vectors X1, S1 in this case can be determined as:

$$r = \frac{{S}_{X 1 S 1}}{{S}_{X 1} \cdot {S}_{S 1}} \\ = \frac{\sum ( {X}_{1 i} - {\overline{X}}_{1} ) ( {S}_{1 i} - {\overline{S}}_{1} ) / n}{\sqrt{\sum {( {X}_{1 i} - {\overline{X}}_{1} )}^{2} / n} \cdot \sqrt{\sum {( {S}_{1 i} - {\overline{S}}_{1} )}^{2} / n}} \qquad ( Eq . 7 )$$

Then, the similarities r to the p feature axes, respectively, are determined for each inspected substrate.

In this way, from defect density information as to m inspected substrates shown in part (a) of FIG. 7A, p feature vectors of independent components shown in part (b) in the figure are determined, and similarities to the p features are determined for m substrates, respectively, as shown in FIG. 7B.

iii) Subsequently, the inspected substrates are classified according to the determined similarities.

For instance, as the criterion as to whether or not each substrate is classified into Feature 1, a threshold of similarity is set as 0.7. Then, substrates having a similarity of 0.7 or more are extracted out of the m substrates. Similar classification is carried out also for the remaining features.

In this way, groups of substrates similar to the p features, respectively, are extracted, and then subjected to classification.

(3) Next, the causal equipment determination process is explained. The causal equipment determination is performed for each one of the p features. A process of causal equipment determination for Feature 1 is described below as an example.

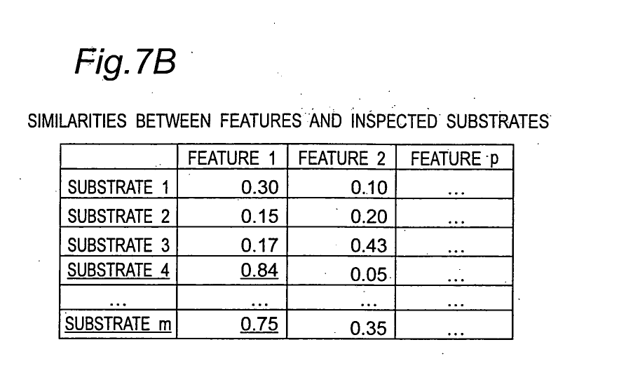

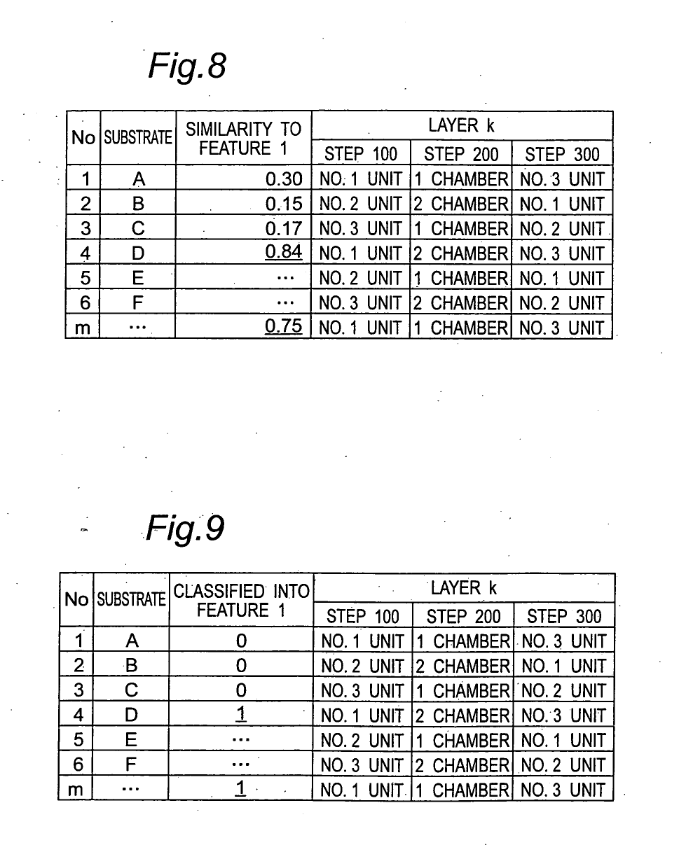

It is assumed that with respect to m substrates, similarities to Feature 1 are obtained, as already described. It is also assumed that production history information as to each of the m substrates has been 5 acquired from the production history DB 21 (see FIG. 2). The similarities and the production history information as to the m substrates are managed in correspondence (association) to the substrates A, B, C, . . . , respectively, as shown in FIG. 8 or 9. FIG. 8 is a representation of the similarities to features by actual numerical values. FIG. 9 shows a result of deciding similarities by a threshold value and representing coincidence or non-coincidence with the features by logical values (binary values) of 1 and 0, respectively. Although equipment units belonging to the layer k steps out of the production history information are described in the example of FIGS. 8 and 9, yet production history relating to equipment unit belonging to other layer steps may also be added if analysis of the equipment units belonging to the other layer steps out of the production history information is necessary.

Now, with a target variable given by similarity and an explanatory variable by production history, causal equipment units are analyzed by looking into correlations between the similarity and the production history. The technique for the analysis of correlations may be a known technique such as variance analysis, chi-square test (independence test), or multivariate analysis.

In the example of FIGS. 8 and 9, the analysis result shows a high correlation to the No. 1 unit of the deposition apparatus at the step 100. Therefore, to obtain confirmation as to this result, a first defect distribution superimposed image is formed by superimposing, on one another, defect distributions of substrates processed by the No. 1 unit of the deposition apparatus in the step 100, and further a second defect distribution superimposed image is formed by superimposing, on one another, defect distributions on the substrates processed by equipment units other than the No. 1 unit 101 (No. 2 unit and No. 3 unit in this example) in the same step 100. Then, as already described, the first defect distribution superimposed image and the second defect distribution superimposed image are displayed in contrast on one display screen 19 as shown in FIG. 10. When the first defect distribution superimposed image and the second defect distribution superimposed image are displayed in contrast on one display screen 19 as in this case, whether or not a causal equipment unit determined by this system is really the cause of the abnormality can be intuitively grasped through the sense of vision and promptly and easily confirmed by a user (including the system operator). Accordingly, once it is confirmed at step 100 that the No. 1 unit of the deposition apparatus is the causal equipment unit, measures such as checking the No. 1 unit of the deposition apparatus can be promptly taken, so that the loss of the production line can be minimized.

It is noted that FIG. 10 as a whole schematically shows the above-described processes by the causal equipment determination system 10 of this embodiment, i.e., processes including the steps of receiving inspection information and history information from the step information collection system 20, and classifying failure distributions, until determining a causal equipment unit.

1. A defect distribution classification method for extracting and classifying defects on substrates processed in a production line including a plurality of steps, wherein
the production line includes an inspection step for acquiring inspection information representing positions of defects on each of the substrates after an end of specified steps, the method comprising:
with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
extracting statistically mutually independent p (where p is a natural number less than m) features from the defect density information having (m×n) components; and
determining similarities between the p features and the defect density information as to the individual substrates, respectively, to classify the substrates for each one of the p features according to the similarities.

2. The defect distribution classification method as claimed in claim 1, wherein
the defect density information is a set of first vectors each having n components associated with the m substrates,
the p features are second vectors each having n components, and
the similarities are determined as correlation coefficients, inner products or covariances between the first vectors as to each of the substrates and the p second vectors.

3. A defect distribution classification system for extracting and classifying defects on substrates processed in a production line including a plurality of steps, wherein
the production line includes an inspection step for acquiring inspection information representing positions of defects on each of the substrates after an end of specified steps, the system comprising:
a defect density distribution acquisition section for, with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
a feature extraction section for extracting statistically mutually independent p (where p is a natural number less than m) features from the defect density information having (m×n) components; and
a classification result acquisition section for determining similarities between the p features and the defect density information as to the individual substrates, respectively, to classify the substrates for each one of the p features according to the similarities.

4. A failure-cause equipment determination method for determining a equipment unit that has caused failure occurrence in a production line that executes a plurality of steps on substrates by using one or more equipment units enabled to execute the individual steps, wherein
the production line includes an inspection step for acquiring inspection information representing positions of defects on each of the substrates after an end of specified steps, the method comprising:
with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
extracting statistically mutually independent p (where p is a natural number less than m) features from the defect density information having (m×n) components;
determining similarities between the p features and the defect density information as to the individual substrates, respectively, to classify the substrates for each one of the p features according to the similarities; and
extracting a causal equipment unit that has caused failure occurrence out of the plurality of equipment units based on the obtained classification result and production history information for identifying equipment units by which the substrates have been subjected to the individual steps, respectively.

5. A failure-cause equipment determination system for determining an equipment unit that has caused failure occurrence in a production line that executes a plurality of steps on substrates by using one or more equipment units enabled to execute the individual steps, wherein
the production line includes an inspection step for acquiring inspection information representing positions of defects on each of the substrates after an end of specified steps, the system comprising:
a defect density distribution acquisition section for, with respect to m (where m is a natural number of 2 or more) substrates subjected to the inspection step, segmenting a surface of each of the substrates into n (where n is a natural number of 2 or more) regions to acquire defect density information having (m×n) components, which represent densities of defects contained in the regions, respectively, based on the inspection information;
a feature extraction section for extracting statistically mutually independent p (where p is a natural number less than m) features from the defect density information having (m×n) components;
a classification result acquisition section for determining similarities between the p features and the defect density information as to the individual substrates, respectively, to classify the substrates for each one of the p features according to the similarities; and
a causal equipment extraction section for extracting a causal equipment unit that has caused failure occurrence out of the plurality of equipment units based on the obtained classification result and production history information for identifying equipment units by which the substrates have been subjected to the individual steps, respectively.

6. The causal equipment determination system as claimed in claim 5, further comprising:
a display processing section for forming a first defect distribution superimposed image by superimposing, on one another, defect distributions of substrates processed by the causal equipment unit and further forming a second defect distribution superimposed image by superimposing, on one another, defect distributions of substrates processed by equipment units other than the causal equipment unit in one same step as a step executed by the causal equipment unit, and then displaying the first defect distribution superimposed image and the second defect distribution superimposed image in contrast on one display screen.

7. A computer program for enabling a computer to run the defect distribution classification method as defined in claim 1.

8. A computer program for enabling a computer to run the causal equipment determination method as defined in claim 4.

9. A computer-readable recording medium in which the computer program as defined in claim 7 is recorded.

10. A computer-readable recording medium in which the computer program as defined in claim 8 is recorded.
